(19) United States
(12) Patent Application Publication
(10) Pub. No.: US 2002/0078687 A1
(43) Pub. Date: Jun. 27, 2002

(54) Apparatus converting ocean wave energy

(76) Inventor: Francis M. ?quot;Jim?quot; Donnelly, Menlo Park, CA (US)

Correspondence Address: Francis M "Jim" Donnelly, C/O Mentor Training, 2880 Zanker Road Suite 205, San Jose, CA, 95134, US

(21) Appl. No.: 09/745,957

(22) Filed: Dec. 21, 2000

(51) Int. Cl. F03C 31/02

(52) U.S. Cl. 60/495; 60/498

(57) ABSTRACT

Apparatus converting ocean wave motion energy to electric power is comprised of a combination of prior art devices floating on catamaran-type pontoons (40) fastened by cables (44) to the floor of a body of water. An auger-type helical member (20) rotates around a horizontal shaft-pipe axle (70) at the water's surface by the force of incoming waves near shore. A multiple-blade impeller (30), with radial blades perpendicular to the shaft-pipe axle, is placed at various points on the same shaft-pipe axle simultaneously with the helical impeller. The blades of the multiple-blade impeller (32a & b) are shaped for maximum conversion of wave energy to boost the rotation of the shaft-pipe axle in high volume, low pressure waves. The common shaft-pipe axle is coupled to gear devices (50) to drive energy conversion devices (50) such as electrical generators.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1.Field of Invention

My Apparatus Converting Ocean Wave Energy is a combination of, and an improvement upon, devices constructed in a way that will convert the energy of waves in a liquid to electricity, or other useful forms of energy, in a manner that is economically feasible and environmentally safe.

2.Description of Prior Art

Prior art devices, such as that of James M. Lapeyre, U.S. Pat. No. 3,818,704, issued Jun. 25, 1974 FIG. 1a, and of Daniel Dementhon, U.S. Pat. No. 4,412,417 issued Nov. 1, 1983 FIG. 1b, relied on vertical movement of waves to rotate buoyant helical impellers. It is necessary for waves to be of significant size and speed in order to create enough torque to rotate these impellers at a rate sufficient to generate substantial measures of electric power. While larger waves create sufficient torque, such waves have caused helical devices to tilt, thereby disturbing the equilibrium of the apparatus. This resulted in an inconsistent level of electric power generated. Previous attempts to achieve economically feasible electric power generation from ocean waves have had a limited degree of success. This is due to the nature of ocean waves having high volume and low pressure.

### SUMMARY OF INVENTION

My Apparatus Converting Ocean Wave Energy comprises the apparatus, its construction, combination of elements and arrangement of parts, which are exemplified in the following detailed disclosure of drawings and the scope of the application indicated in the claims of this patent application. This invention combines four major elements:

1) a catamaran-type float,

2) a shaft-pipe axle,

3) a helical impeller, and

4) a multiple blade axial fan-type impeller.

The catamaran-type float supports the shaft-pipe axle. The shaft-pipe axle may be constructed in multiple sections. The helical impeller is attached to and wound around said shaft-pipe axle. The multiple blade axial fan-type impeller is attached to same said shaft-pipe axle. Horizontal water wave motion acting upon said impellers causes them to rotate the shaft-pipe axle. Said shaft-pipe axle drives a gear mechanism and an energy conversion device such as a generator. Said shaft-pipe axle may be connected a variation of gear mechanisms by a firm or flexible shaft.

### DRAWING FIGURES

Drawing Views

FIGS. 1a, b & c—Prior Art FIG. 2 —Top, front, right perspective showing the tapered first helical impeller and the combination of two different impellers in line on the same shaft-pipe axle. Support assembly with pontoons, support bars and anchoring cables is shown.

FIG. 3a —Front view of the fan assembly.

FIG. 3b —Front view of alternative fan assembly.

FIG. 3c —Top, front, right perspective view of two fan assemblies showing them staggered so as the wave passes through the blades of the first fan assembly, it rotates the fan and axle, and hits the blade of the subsequent fan spaced between the blades of the first.

FIG. 4 —Front view of pontoons and helical impeller showing how the axle and impellers are supported. It also shows cables for anchoring.

FIG. 5 —Right side view showing sections of the helical impellers of varying itches, a helical impeller with two foils, and the sets of axial fan impellers placed between the helicals. It also shows the placement of the gear and generator assemblies.

FIG. 6 —Top view

### Reference Numbers in Drawings

20 —Helical impeller

30 —Fan assembly

32a —Fan blades

32b —Alternative fan blades

34 —Fan hub

40 —Pontoon

42 —Support bars

44 —Anchoring cables

46 —Shaft collar

48 —Collar bracket

50 —Gear mechanism and energy conversion device assembly

70 —Shaft-pipe axle

### DETAILED DESCRIPTION OF THE INVENTION

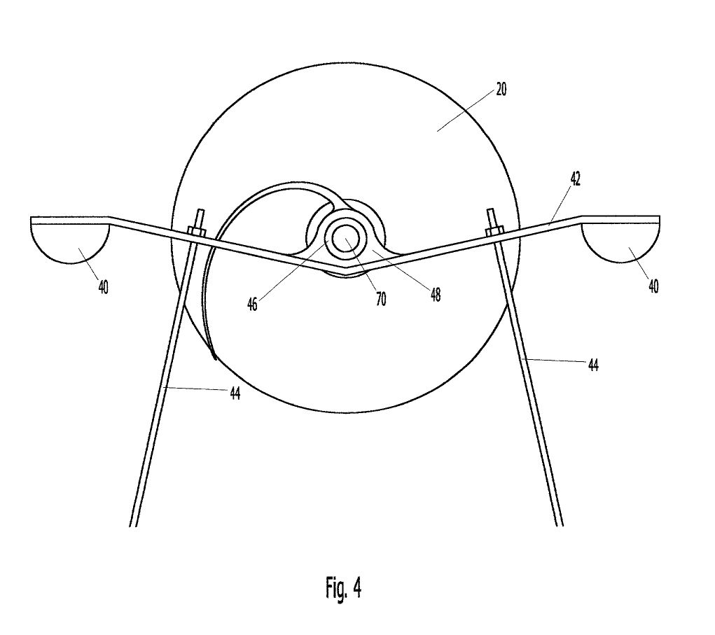

A preferred embodiment of my Apparatus Converting Ocean Wave Energy is illustrated in FIG. 2. A catamaran-like structure composed of two continuous pontoons (40) with cross members as support bars (42) provides the flotation support base for the entire apparatus. The pontoons will be of sufficient size to float the weight of the apparatus so that the shaft-pipe axle is at water level in a calm body of water. The central shaft-pipe axle (70) turns inside a shaft collar (46) containing bearings or rollers allowing the axle to rotate easily (FIG. 4). The bearings are held in place by the collar bracket (48) attached to the support bar (42). This assembly is moored to the ocean floor by anchoring cables (44) attached to each support bar.

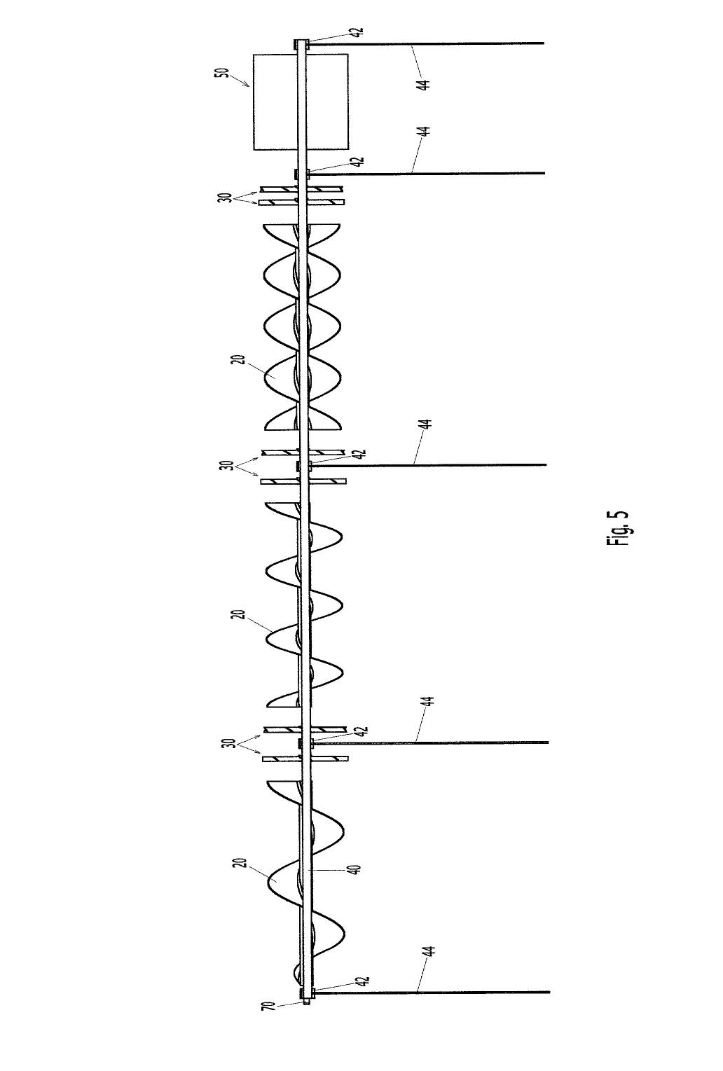

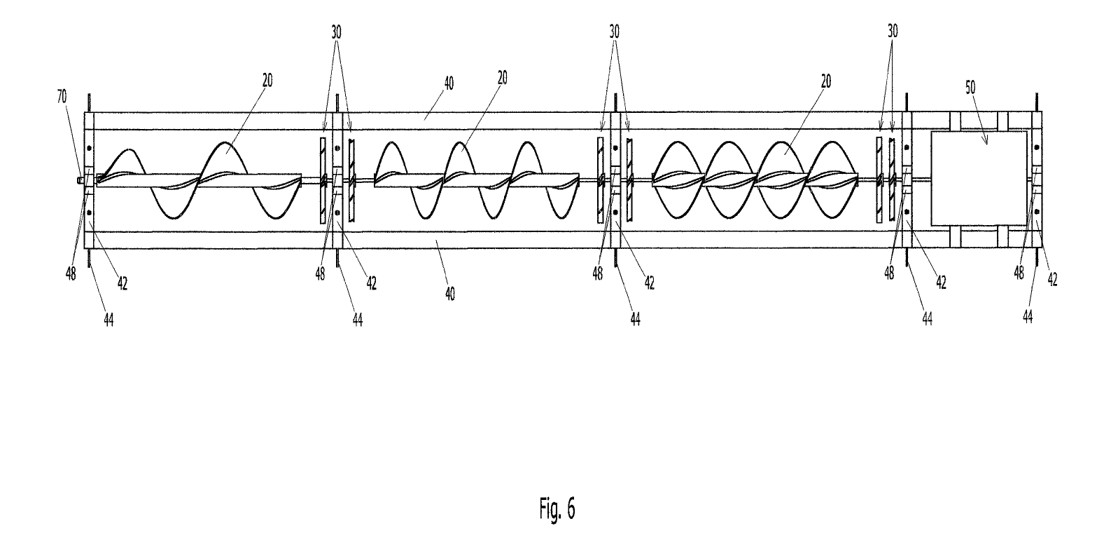

The helical impeller (20) is attached to the axle so that the impact of the water's surface waves on the impeller cause the impeller to turn, thereby rotating the axle. The foil of the impeller will be made of a lightweight, sturdy carbon material to minimize the inertia of the apparatus making it easier to turn. The pitch of the helical impeller may vary from one apparatus to another, to accommodate the unique wave characteristics for each geographic location. The helical impeller may also have a multiplicity of pitches on the same apparatus as shown in FIG. 5. Also in FIGS. 2 & 5, the helical impeller at the front end of the apparatus is tapered to allow a gradual build-up of force on the impeller and axle to reduce shock to the structures. The helical impeller may have a multiplicity of foils. FIGS. 5 & 6 show the third helical impeller (20), counting from left to right, as having two foils placed 180 degrees opposite each other.

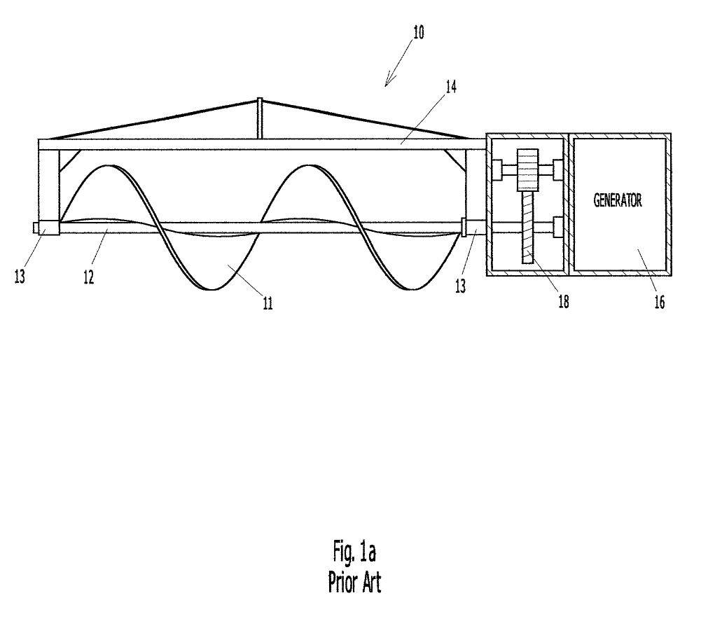

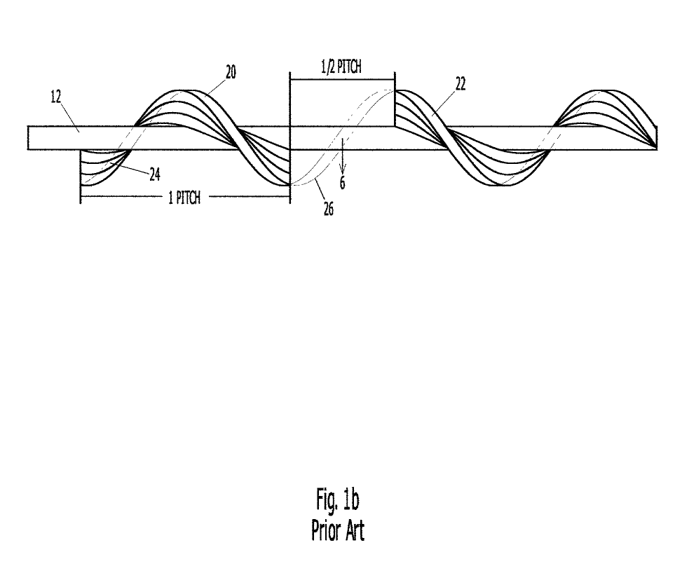

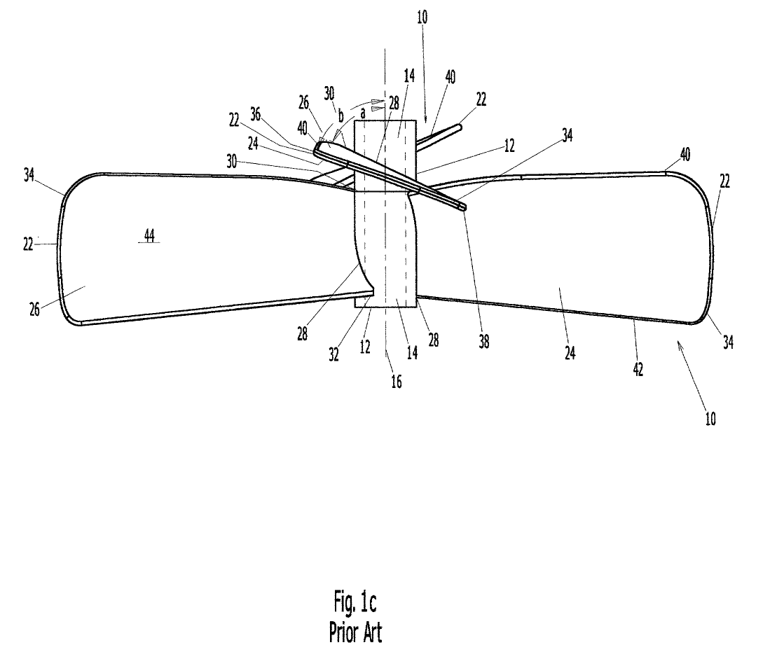

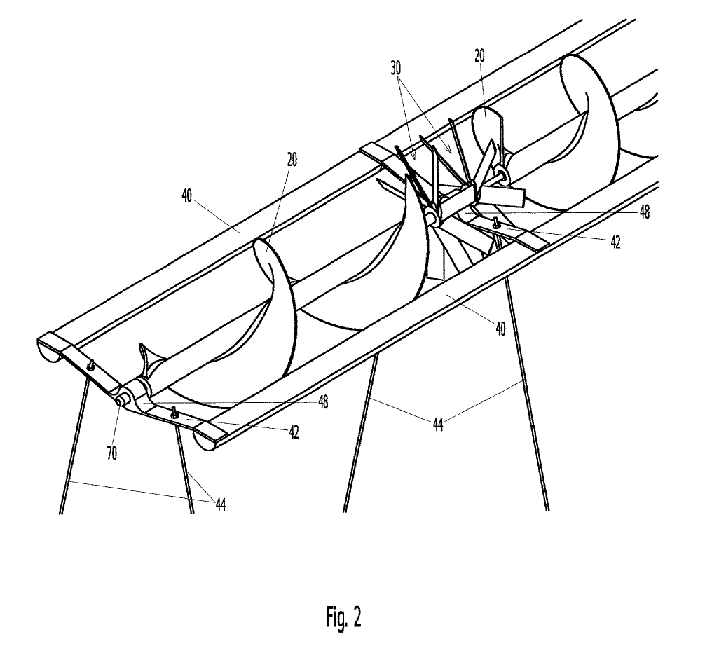

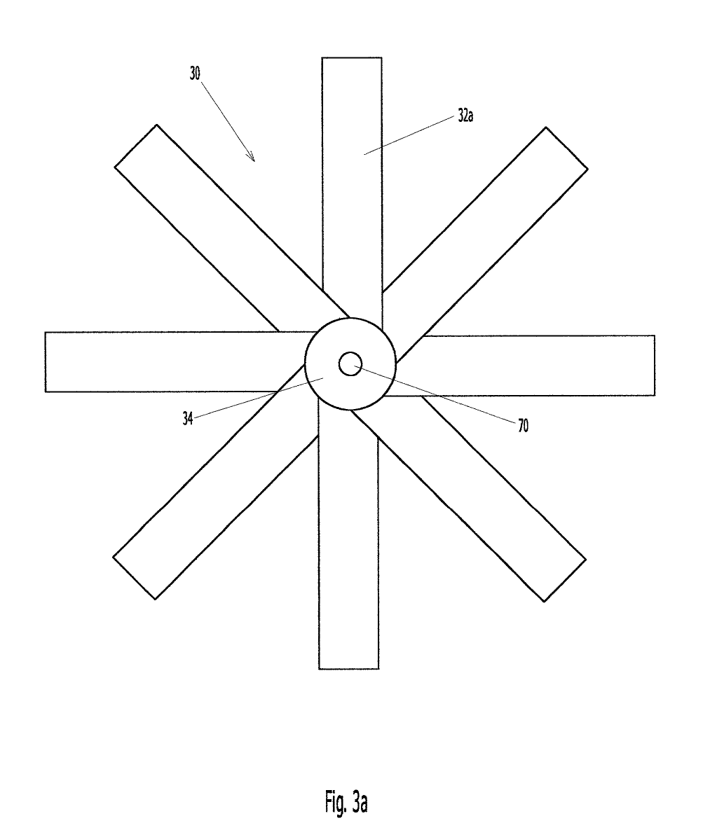

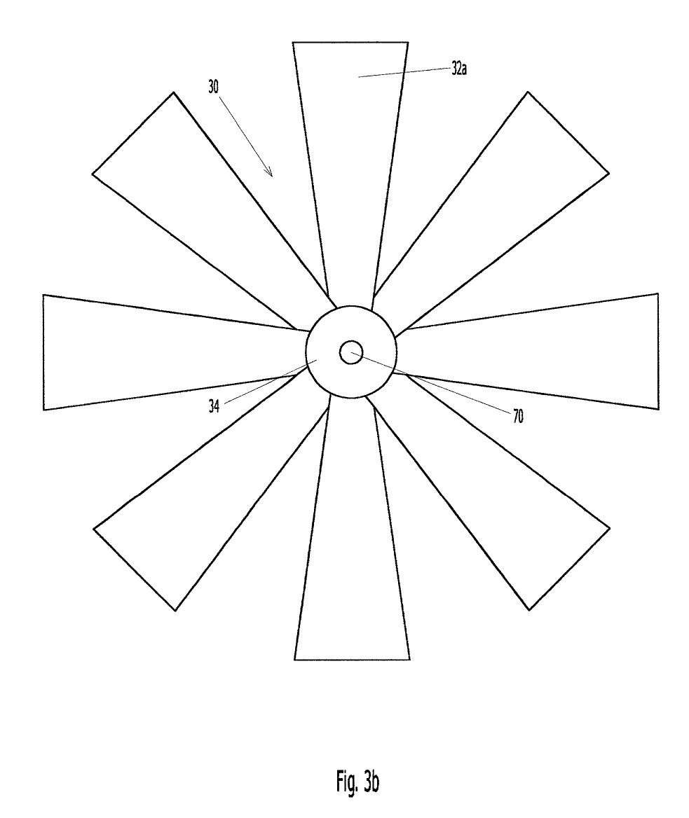

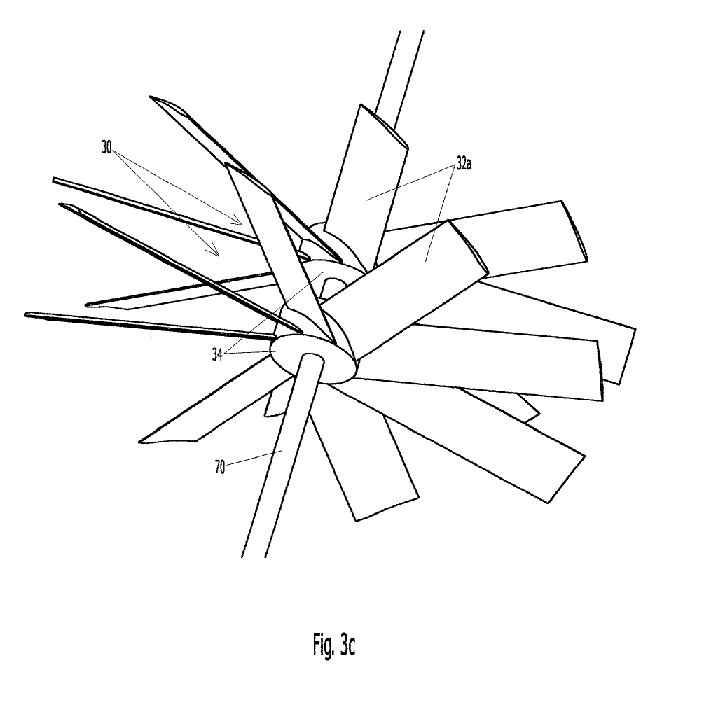

A set of axial fan impellers, shown in FIG. 3c, are attached to the shaft-pipe axle just behind the helical impeller (FIG. 2). The angle of the axial fan blades is set so as to accelerate the speed of rotation of the axle. It is necessary to add the axial fan impeller to my apparatus to accommodate the low-pressure force of ocean waves. The blades of this impeller are modeled after impellers for mixing fluids (see prior art FIG. 1c) and from fans for circulating air. These blades may have either a concave curvature or may be twisted as are marine propellers or a combination of both. The blades may also have a variety of shapes as shown in FIG. 3b and may be aerodynamically designed comparable to airplane wings.

This combination of the flotation assembly and the variety of impellers is the essence of my invention. While the large, lightweight foil of the helical impeller is needed to overcome the inertia of the apparatus, the axial fan impeller boosts the rate of rotation of the axle. With the pontoons (40) and support bars (42) holding the axle consistently level, the entire apparatus is capable of utilizing the maximum degree of lateral energy from the wave motion. This solves the present dilemma of the lack of sufficient speed of rotation due to the low-pressure nature of ocean waves. An assembly of gears and energy conversion devices (50), such as electric generators, are supported on the structure along with and connected to the axle (FIGS. 5 & 6). The apparatus will be placed far enough away from shore so that it will not be in the range of breaking waves. This will eliminate stress on the apparatus from the downward force of the breaking waves. It will be placed so that the waves will break after they pass the apparatus.

### OBJECTS AND ADVANTAGES

Accordingly, the objects and advantages of my Apparatus Converting Ocean Wave Energy are:

1) to provide support of the impellers and shaft-pipe axle that maintains them at a substantial level equilibrium with respect to the overall water surface.

2) to create a rapid rotation of the axle by the inclusion of axial fan-type impellers making the maximum utilization of the lateral movement of ocean waves.

3) to convert the energy of high volume, low pressure liquid waves to substantial levels of useful energy making it commercially feasible.

To address these objects, my Apparatus Converting Ocean Wave Energy:

1) establishes equilibrium of the helical impellers by attaching them to a shaft-pipe axle supported on a catamaran-type float that is of a length sufficient to maintain constant equilibrium at the water surface level. This enables my invention to utilize, more completely, energy from the horizontal movement of waves, whereas prior art devices relied on vertical movement of waves to rotate buoyant impellers.

2) uses two types of impellers. First, a helical impeller, when impacted upon by high volume, low-pressure waves, overcomes inertia and initiates rotation of the shaft-pipe axle stated in 1) above. The helical impeller may have a multiplicity of foils. In addition to the helical impeller, an axial fan-type, multiple-blade impeller, constructed with blades at appropriate angles to accelerate the rotation of said shaft-pipe axle, is attached to same shaft-pipe axle simultaneously.

### Conclusion

Accordingly, it is shown that the catamaran-type float, extended to a substantial length, will maintain the apparatus in level equilibrium. This enables my Apparatus Converting Ocean Wave Energy to make maximum utilization of horizontal wave energy. The shape of the helical impeller, which is attached to the shaft-pipe axle, enables it to rotate easily when impacted upon by high volume, low pressure waves. This overcomes inertia and initiates rotation of the impeller and the shaft-pipe axle. The blade configuration of the axial fan-type, multiple-blade impeller, attached simultaneously to the same axle, utilizes the force of the high volume wave to accelerate the rotation of the shaft-pipe axle giving the needed speed to drive the energy conversion device(s) attached to it. Prior devices were not able to generate electricity at a level sufficient for commercial implementation. My Apparatus Converting Ocean Wave Energy will solve that problem.

I claim:

1. Apparatus for converting the energy of surface waves in a liquid, such apparatus comprising of, in combination:
a) a long, continuous catamaran-type float.
b) a shaft-pipe axle supported on said catamaran-type float with said shaft-pipe held at the waters' surface.
c) one or more helical members, resembling a drill bit or auger, attached to and wound around said shaft-pipe axle.
d) one or more multiple blade impellers on said shaft-pipe axle, with impeller blades perpendicular to said shaft-pipe axle.

2. Shaft-pipe axle as defined in claim 1 may be connected by a solid or flexible coupling member to an energy conversion device.

3. Apparatus as defmed in claim 1 has buoyancy that is substantially uniform throughout its length.

4. Helical member(s) of claim 1 may have a variation of, or combination of, a plurality of pitches.

5. Helical member(s) of claim 1 may have a plurality of diameters in combination.

6. Helical member(s) of claim 1 may have more than one foil.

7. Helical member(s) of claim 1 may be solid or hollow.

8. Helical member(s) of claim 1 may be gradually tapered at the front end.

9. Multiple blade impeller(s) of claim 1 may have axial fan-type blades curved and beveled at various degrees and angles.

10. Multiple blade impeller(s) of claim 1 may have blades in a variety of shapes.

11. Multiple blade impeller(s) of claim 1 may be placed individually or in groups at multiple points between sections of said helical impeller in sequence on same said shaft-pipe axle.

12. Apparatus as defined in claim 1 has buoyancy such that portions of the attached impellers, of claims 1 through 7, extend above the surface of said liquid and portions of said impellers are submerged.
